(19) United States
(12) Patent Application Publication
(10) Pub. No.: US 2026/0236746 A1
(43) Pub. Date: Aug. 13, 2026

(54) ID-Based One-Sided Model Life Cycle Management

(71) Applicant: Telefonaktiebolaget LM Ericsson (PUBL), Stockholm (SE)

(72) Inventors: Mattias FRENNE, UPPSALA (SE); Jingya LI, GÖTEBORG (SE); Henrik RYDÉN, STOCKHOLM (SE); Yufei Blankenship, KILDEER, IL (US); Roy TIMO, KUNGSÄNGEN (SE)

(21) Appl. No.: 19/474,815

(22) PCT Filed: Apr. 12, 2024
(86) PCT No.: PCT/IB2024/053626

§ 371 Date: Oct. 13, 2025

Related U.S. Application Data
(60) Provisional application No. 63/496,306, filed on Apr. 14, 2023.

(51) Int. Cl. G06N 3/0455

(52) U.S. Cl. CPC G06N 3/0455

(57) ABSTRACT

According to some embodiments, a method performed by a wireless device comprises receiving a key from a network node. The key is associated with a machine learning (ML) model and one or more conditions, scenarios, and configurations. The method further comprises performing an action with respect to the key, depending on whether the key matches a stored key or a key of a currently running ML model.

### TECHNICAL FIELD

The present disclosure generally relates to communication networks, and more specifically to identifier-based one-sided model life cycle management (LCM) for artificial intelligence (AI)/machine learning (ML) models for wireless communications.

### BACKGROUND

Artificial intelligence (AI) and machine learning (ML) are considered, both in academia and industry, as promising tools to optimize the design of the air-interface in wireless communication networks. Example use cases include using autoencoders for channel state information (CSI) compression to reduce the feedback overhead and improve channel prediction accuracy; using deep neural networks for classifying line-of-sight (LOS) and non-LOS (NLOS) conditions to enhance positioning accuracy; and using reinforcement learning for beam selection at the network side and/or the user equipment (UE) side to reduce signaling overhead and beam alignment latency; using deep reinforcement learning to learn an optimal precoding policy for complex multiple-input multiple-output (MIMO) precoding problems.

Third Generation Partnership Project (3GPP) New Radio (NR) Release 18 standardization work includes a study item on AI/ML for the NR air interface. This study item will explore the benefits of augmenting the air-interface with features enabling improved support of AI/ML based algorithms for enhanced performance and/or reduced complexity/overhead. Through studying a few selected use cases (CSI feedback, beam management, and positioning), the study item intends to lay the foundation for future air-interface use cases leveraging AI/ML techniques.

When applying AI/ML on air interface use cases, different levels of collaboration between network nodes and UEs can be considered. One use case is no collaboration between network nodes and UEs. In this case, a proprietary ML model operating with the existing standard air-interface is applied at one end of the communication chain (e.g., at the UE side), and the model life cycle management (e.g., model selection/training, model monitoring, model retraining, model update) is done at this node without inter-node assistance (e.g., assistance information provided by the network node).

Another use case is limited collaboration between network nodes and UEs. In this case, a ML model is operating at one end of the communication chain (e.g., at the UE side), but this node gets assistance from the node(s) at the other end of the communication chain (e.g., a next generation Node B (gNB)) for its AI model life cycle management (e.g., for training/retraining the AI model, model update).

A third use case is joint ML operation between network nodes and UEs. In this case, the AI model may be split with one part located at the network side and the other part located at the UE side. Thus, the AI model includes joint training between the network and UE, and the AI model life cycle management involves both ends of a communication chain.

Building the AI model, or any machine learning model, includes several development steps where the actual training of the AI model is just one step in a training pipeline. An important part in AI development is the ML model lifecycle management. This is illustrated in FIG. 1, which is an illustration of training and inference pipelines, and their interactions within a model lifecycle management procedure. The model lifecycle management typically consists of a training (re-training) pipeline, a deployment stage to make the trained (or re-trained) AI model part of the inference pipeline, an inference pipeline, and a drift detection stage that informs about any drifts in the model operations.

The training (re-training) pipeline that may include data ingestion, data pre-processing, model training, model evaluation, and model registration. Data ingestion refers to gathering raw (training) data from a data storage. After data ingestion, there may also be a step that controls the validity of the gathered data.

Data pre-processing refers to feature engineering applied to the gathered data, e.g., it may include data normalization and possibly a data transformation required for the input data to the AI model.

Model training refers to the actual model training steps as previously outlined.

Model evaluation refers to benchmarking the performance to a model baseline. The iterative steps of model training and model evaluation continues until the acceptable level of performance (as previously exemplified) is achieved.

Model registration refers to registering the AI model, including any corresponding AI-metadata that provides information on how the AI model was developed, and possibly AI model evaluations performance outcomes.

The deployment stage makes the trained (or re-trained) AI model part of the inference pipeline.

The inference pipeline may include data ingestion, data pre-processing, model operational, and data and model monitoring. Data ingestion refers to gathering raw (inference) data from a data storage.

The data pre-processing stage is typically identical to corresponding processing that occurs in the training pipeline.

Model operational refers to using the trained and deployed model in an operational mode.

Data and model monitoring refers to validating that the inference data are from a distribution that aligns well with the training data, as well as monitoring model outputs for detecting any performance, or operational, drifts.

A drift detection stage informs about any drifts in the model operations.

FIG. 2 is a block diagram illustrating a functional framework used for studying different network-UE collaboration levels for the AI for physical layer (PHY) use cases.

The AI/ML models being discussed in the Rel-18 study item on AI/ML for the New Radio (NR) air interface may be categorized into the following two types: one-sided and two-sided.

The one-sided AI/ML model may be a UE-sided AI/ML model whose inference is performed entirely at the UE, or a network-sided AI/ML model whose inference is performed entirely at the network.

The two-sided AI/ML model refers to a paired AI/ML model over which joint inference is performed across the UE and the network, i.e., the first part of the inference is firstly performed by UE and then the remaining part is performed by gNB, or vice versa.

FIG. 3 illustrates an example use case of autoencoder (AE)-based channel state information (CSI) feedback/report, where an encoder (UE-part of the two-sided AE model) is operated at a UE to compress the estimated wireless channel, and the output of the encoder (the compressed wireless channel information estimates) is reported from the UE to a gNB. The gNB uses a decoder (network-part of the two-sided AE model) to reconstruct the estimated wireless channel information.

There currently exist certain challenges. For example, for one-sided AI/ML models, the model inference is performed entirely at one-side of a communication chain (e.g., the UE-side for an uplink-/downlink-based AI/ML feature). The node performing AI model inference (e.g., a UE), however, may need assistance from the node(s) at the other end of the communication chain (e.g., a gNB) to help AI/ML model life cycle management. For example, the node may require additional data collection for training/retraining its AI/ML model, model update, model monitoring, model selection/fallback/switching.

Consider, for example, a UE-sided model for downlink transmit beam prediction. A UE may train different AI/ML models for different scenarios and/or different network configurations.

The different scenarios might be, for example, macro-urban/high-rise-building scenarios, indoor/outdoor scenarios, low speed/high-speed scenarios, under-normal-UE-power-consumption-mode or under-reduced-UE-power-consumption-mode etc. The different network configurations might include, for example, different TX beam patterns, different number of activate antenna ports/elements, different traffic load levels, etc.

The AI/ML model life cycle management problem is challenging for the UE, because the UE may move from one cell to another cell or from network of one operator to another operator. Even if the UE is stationary, the environment may change over time and the network node may perform reconfiguration. Therefore, the UE is expected to encounter a variety of different deployment scenarios and network configurations during its normal operation. The UE needs to be able to adapt its AI/ML model (e.g., activate/deactivate/update/switch/re-train the UE model) quickly so that satisfactory UE performance can be maintained continuously. In real network deployments, the UE needs to identify/select a model that is applicable for the current scenario and/or the current network configuration.

The abovementioned problem also holds for one-sided models in the network. A gNB with different AI/ML models for different scenarios and/or UE configurations will need to identify which scenario and/or UE configuration is applicable. In general, it is a problem how to identify the applicable model(s) to use for one-sided model cases.

3GPP is discussing potential solutions for identifying an applicable one-sided model at a UE. One such solution requires a globally unique model ID for each UE-sided model. For example, the UE may have several AI/ML models covering different scenarios and/or network configurations, and each model is identified with a globally unique ID. Alternatively, a globally unique ID may be defined for the configuration/scenario/condition/dataset to assist the UE with one-sided model life cycle management. Then, the global model scenario/dataset/configuration/condition ID may be used to identify the UE-sided model that is applicable for a specific scenario and network configuration. Thus, all UE-sided models that are trained by different UE/chip-set vendors for a specific AI-based feature/functionality are identified with, for example, a global ID. A catalog or register of such global IDs is kept and maintained by some party.

However, defining a global ID to be managed by a central entity for all one-sided models/scenarios/configurations/conditions/datasets is challenging. Multiple models may be trained by each and every UE/chipset vendor, and the AI/ML models may cover multitude of different scenarios and configurations. Moreover, different vendors may have different definitions of scenarios and configurations. Different vendors may have different conditions on updating/retaining a model or adding a new model for a certain scenario/configuration or creating a new dataset. Thus, a global model/configuration/scenario/dataset ID, if defined in 3GPP, should be able to address all these possible model training cases, scenarios, configurations, applicable conditions, and datasets. It is non-trivial to define criteria under which a new global ID should be added.

In addition, there is a problem of how to maintain the global IDs, especially considering that there can be multiple one-sided AI/ML based features introduced in NR (5G) or 6G, thus, an effort is required for keeping track of global IDs per feature. It is a problem and additional effort to decide who should be the entity that maintains such a register of global IDs. A global trustworthy source needs to be identified for this task, which is a problem.

### SUMMARY

As described above, certain challenges currently exist with artificial intelligence (AI)/machine learning (ML) models for wireless communications. Certain aspects of the disclosure and their embodiments may provide solutions to these or other challenges. For example, in particular embodiments, a first node, which is located at one end of a communication chain (e.g., the network side), generates a key that identifies a scenario, a set of its configuration parameters, and/or a training dataset. The first node signals the key to the second, where the second node is located at the other end of the communication chain (e.g., the user equipment (UE)). The second node uses the key for managing the lifecycle of one-or-more one-sided models.

The key may take various formats. For example, the key may be a string of letters and/or numbers, which can be equivalently represented by binary numbers. The key may be (pseudo) randomly generated. In one example, the key is generated by a hash function, where a unique key is provided for the applicable condition under which the model can function. The applicable condition may include one or more of: training dataset ID, network configuration parameters, condition parameters (e.g., signal to interference and noise ratio (SINR) range, interference, additive white Gaussian noise (AWGN) or fading channel, synchronization error range of network nodes), a network identifier, and/or a UE identifier.

A key can thus be (pseudo-)randomly generated for an applicable condition of a one-sided model at the second node, where the collision probability is kept low. Here the collision refers to mapping two different inputs to a same (pseudo-)random key value, where the input carries the information about the applicable condition of the model. The first node shares the key with the second node, during the model training session of a one-sided model at the second node, e.g., by transmitting the key together with the training data collection configuration parameters.

A key can also be randomly generated for a new condition/configuration/scenario where model training at the second node did not observe before. During the model operation, the first node shares the key with the second node, when it changes its configuration, or/and when it detects the changes of the scenario.

A key may be generated by combining a unique hardware identifier (for example a unique medium access control (MAC) address) with a timestamp and/or a pseudo-random string/number. For example, the MAC address of the device creating the key. Alternatively, if the scenario classification is performed offline outside the radio access network (RAN) (e.g., in a cloud environment), then the MAC address of the machine/instance performing the operation may be used.

During operation, the key is used to identify a one-sided model to be selected for the second node to use under the current scenario/configuration/condition. If no model corresponding to the key can be found, then, the second node cannot activate a model immediately. Instead, the second node may fall back to a non-ML algorithm, trigger new training data collection, and/or trigger model monitoring procedure.

The following procedures can be considered during model operation.

Procedure 1 is for indicating condition/configuration/scenario changes and support model life cycle management (LCM) accordingly. The first node (e.g., a network node) updates its configuration or detects scenario/condition change that is associated to an AI-model-based feature. The first node transmits/broadcasts/multicasts a key generated based on the updated configuration/scenario/condition to the second node (e.g., a UE).

The second node receives the key and compares it with the key for the running model (optionally, also compare it with the key(s) for all the stored models) for this AI feature. The second node makes (initial) model LCM decisions. If no stored key matches to the received node, then, the second node automatically fallback to non-ML feature/algorithm or requests fallback, or/and trigger model monitoring procedure, or/and trigger data collection procedure. If the key for the running model matches to the received key, then continue using the current model. If one stored key of the non-running model matches the received key, then, activate/switch-to this matched model.

Procedure 2 is for reporting the capability of the second node to the first node, and support model LCM, accordingly. The second node (e.g., a UE) reports the key(s) for all its stored or currently applicable/available one-sided model(s) for an AI-model-based feature to the first node (e.g., a network node).

The first node indicates model LCM operations to the second node based on the received keys. If at least one of the received key(s) matches the current condition/configuration/scenario, then, the first node selects the matched model(s) for the second node, and indicates selection result to the second node. The indication of the selected result may be via the first node sending the selected key(s) to the second node. If none of the received key(s) matches the current condition/configuration/scenario, then, configure the second node to fallback to non-ML feature/algorithm, or/and trigger data collection procedure for the second node.

The first node may keep track of the reported keys from a list of second nodes. If the current configuration is Config #A, and most (or all) of the second nodes report the support of a different configuration (e.g., Config #B) via the keys, then the first node may perform reconfiguration to change from Config #A to Config #B.

In general, particular embodiments include a randomly or pseudo-randomly generated key consisting of a string of letters and numbers (including binary numbers) to identify a scenario/condition/configuration/dataset for a one-sided model LCM. In one example, the key is generated by a hash function.

In particular embodiments, the key is generated at a first node, and shared/signaled to a second node that runs the one-sided model to, e.g., identify applicable model(s) to activate/deactivate from stored one-sided models. The key may be used for various other life cycle management purposes of the AI/ML model, for example, for model monitoring, model update, model switch, and/or training data-collection purposes.

According to some embodiments, a method performed by a wireless device comprises receiving a key from a network node. The key is associated with a ML model and one or more conditions, scenarios, and configurations. The method further comprises performing an action with respect to the key.

In particular embodiments, the action comprises, if the key does not match a stored key, then performing one or more of the following: fallback to a non-ML feature/algorithm; request fallback to a non-ML feature/algorithm; trigger an ML-model monitoring procedure; and/or trigger a data collection procedure; if the key matches a key associated with a currently running ML model, then continue using the currently running ML model; and if the key matches a stored key, activate or switch to an ML model associated with the key.

In particular embodiments, the method further comprises transmitting a list of stored keys to the network node.

According to some embodiments, a wireless device comprises processing circuitry operable to perform any of the wireless device methods described above.

According to some embodiments, a method performed by a network node comprises determining a key associated with a ML model and one or more conditions, scenarios, and configurations and transmitting the key to a wireless device.

In particular embodiments, the method further comprises receiving a list of stored keys from the wireless device; selecting one key from the list of stored keys; and transmitting the selected key to the wireless device. Selecting one key may be based on one or more of a current conditions, scenarios, and configurations.

According to some embodiments, a network node comprises processing circuitry operable to perform any of the network node methods described above.

Also disclosed is a computer program product comprising a non-transitory computer readable medium storing computer readable program code, the computer readable program code operable, when executed by processing circuitry to perform any of the methods performed by the wireless devices described above.

Another computer program product comprises a non-transitory computer readable medium storing computer readable program code, the computer readable program code operable, when executed by processing circuitry to perform any of the methods performed by the network node described above.

Certain embodiments may provide one or more of the following technical advantages. For example, particular embodiments facilitate one-sided model LCM operations to adapt to different conditions/configurations/scenarios without a need to define/store/register/maintain a list of global pairing IDs. Thus, the method does not require a standardized global ID registration procedure and it has lower standardization complexity and maintenance compared to the centralized global ID registration approach.

Particular embodiments facilitate a UE to use a UE-sided model that is applicable for a specific condition, and thereby ensure the performance of the one-sided AI/ML model-based feature/functionality.

### BRIEF DESCRIPTION OF THE DRAWINGS

The present disclosure may be best understood by way of example with reference to the following description and accompanying drawings that are used to illustrate embodiments of the present disclosure. In the drawings:

FIG. 1 illustrates an example of training and inference pipelines and their interactions within a model lifecycle management procedure;

FIG. 2 is a block diagram illustrating a functional framework used for studying different network-user equipment (UE) collaboration levels for the artificial intelligence (AI) for physical layer (PHY) use cases;

FIG. 3 illustrates an example use case of autoencoder (AE)-based channel state information (CSI) feedback/report;

FIG. 4 illustrates an example defining one key for one combination of AI/ML model and its operating condition;

FIG. 5 illustrates an example where one key is defined for one operating condition of the AI model, where a model may be trained to operate under multiple conditions;

FIG. 6 illustrates an example where one key is defined for one AI/ML model, where each model has its associated operating conditions;

FIG. 7 illustrates an example of the usage of stored keys for trained one-sided models at the second node together with the signaling of a key from the first node to the second node during operation;

FIG. 8 illustrates an example of key-based UE capability reporting for one-sided model life cycle management (LCM);

FIG. 9 shows an example of a communication system, according to certain embodiments;

FIG. 10 shows a user equipment (UE), according to certain embodiments;

FIG. 11 shows a network node, according to certain embodiments;

FIG. 12 is a block diagram of a host, according to certain embodiments;

FIG. 13 is a block diagram illustrating a virtualization environment in which functions implemented by some embodiments may be virtualized;

FIG. 14 shows a communication diagram of a host communicating via a network node with a UE over a partially wireless connection in accordance with some embodiments;

FIG. 15 is a flowchart illustrating an example method in a wireless device, according to certain embodiments; and

FIG. 16 is a flowchart illustrating an example method in a network node, according to certain embodiments.

### DETAILED DESCRIPTION

As described above, certain challenges currently exist with artificial intelligence (AI)/machine learning (ML) models for wireless communications. Certain aspects of the disclosure and their embodiments may provide solutions to these or other challenges. For example, in particular embodiments, a first node, which is located at one end of a communication chain (e.g., the network side), generates a key that identifies a scenario, a set of its configuration parameters, and/or a training dataset. The first node signals the key to the second, where the second node is located at the other end of the communication chain (e.g., the user equipment (UE)). The second node uses the key for managing the lifecycle of one-or-more one-sided models.

Particular embodiments are described more fully with reference to the accompanying drawings. Embodiments are provided by way of example to convey the scope of the subject matter to those skilled in the art.

As used herein, the first node may be a UE or a network node. The second node also may be a UE or a network node. Thus, both first node and second node may be UEs, or one node is a UE while the other is a network node, for example.

The non-limiting term “network node” is used and it may correspond to any type of radio network node or any network node, which communicates with a UE and/or with another network node. Examples of network nodes are NodeB, eNodeB, gNodeB (or gNB), gNB-DU, gNB-CU, MeNB, SeNB, a network node belonging to master cell group (MCG) or secondary cell group (SCG), base station (BS), multi-standard radio (MSR) radio node such as MSR BS, network controller, radio network controller (RNC), base station controller (BSC), relay, device to device (D2D) UE to network relay, donor node controlling relay, base transceiver station (BTS), access point (AP), transmission points (TP), transmission and reception points (TRP), transmission nodes, remote radio unit (RRU), remote radio head RRH), nodes in distributed antenna system (DAS), core network node (e.g. mobile switching center (MSC), mobility management entity (MME), etc.), operations and management (O&M), operations support system (OSS), self-optimizing network (SON), positioning node (e.g. evolved serving mobile location center (E-SMLC)), location server, location management entity (LMF), minimization of drive test (MDT), etc.

The non-limiting terms “UE” or a “wireless device” are used interchangeably. The UE herein may be any type of wireless device capable of communicating with a network node or another UE over radio signals. The UE may also be a radio communication device, target device, device to device (D2D) UE, machine type UE or UE capable of machine to machine communication (M2M), low-cost and/or low-complexity UE, a sensor equipped with UE, Tablet, mobile terminals, smart phone, laptop embedded equipped (LEE), laptop mounted equipment (LME), universal serial bus (USB) dongles, customer premises equipment (CPE), an Internet of things (IoT) device, or a narrowband IoT (NB-IoT) device, etc.

Some embodiments include the definition and generation of random keys. The first node (e.g., the network) may create a hashed value based on the first node configuration parameters, the received second node configuration parameters, the scenario parameters, and/or condition parameters. The first node takes these parameters as input to a hashing function.

An input bit string A is be constructed using the characteristic information of the first node configurations, second node configuration, scenarios, conditions. The input bit string A is passed as input to the hash function. The output of the hash function is bit string B. The random key is then obtained from bit string B.

The random key may be string B directly. Alternatively, string B is modified before taken as the random key. The modification may be one or more of the following.

String B may be truncated to reduce its length. The truncation removes a subset of bits from string B. The bits can be removed from the front, or from the end of string B, or from another known location.

String B may be extended to increase its length by padding some bits. The padding may be at the front or at the end of string B. The padding bits may be predefined, e.g., all zeros, or all ones, or a known set of bits (e.g., a network ID or a UE ID).

String B may be modified by a set of bits, e.g., a section of string B bits is xor-ed with a network ID or a UE ID.

The input string A may include one or more of the following information: (a) a network vendor ID and/or a network equipment ID; (b) a cell ID and/or a tracking area ID; (c) a UE vendor ID, a UE logical ID, and/or a UE equipment ID; (d) a training dataset ID, a training data storage entity ID, and/or a training entity ID; (e) a training session ID and/or a time stamp (e.g., year/month/date/hour/min) of the training session; (f) a Decoder ID, a Decoder storage entity ID, (g) an Encoder ID, an Encoder storage entity ID; and/or a UE mobility range ID; (h) a UE/NW power/energy level statues ID; (i) a UE/NW antenna configuration ID; (j) a scenario ID; (k) NR numerology number: Subcarrier Spacing (e.g. 15, 30, 60 . . . , kHz) Symbol Duration (1000, 500, 250 μs, . . . ), carrier frequency (e.g. 0, 7, 2, 28 GHZ); (k) number of antenna ports, beams, active antenna elements, and/or antenna panels; (l) traffic load level ID; and/or (m) a unique UE ID, e.g. IMSI (International Mobile Subscriber Identifier).

The hashing function may, for example, comprise a Secure Hash Algorithm (SHA), e.g. (SHA-3, SHA-256). The first node then calculates the hashed value, which is used as the key. The method for creating a hash value does not need to be based on the model parameters, but may be used by any information related to the training of the one-sided models. The selection on the number of bits to use as a hash-value may be based on: (a) the expected number of models to be operational; (b) the frequency of sending the key values as part of UE capabilities; (c) method of transmitting key values, such as downlink or uplink based and/or broadcast/multicast/unicast transmission from network; and/or (d) if the UE response after receiving a network key includes some “decryption” response of the received key, then, for example, the UE may respond with an agreed UE-NW function that can “decrypt” the key. This may be used to detect potential key collisions. In such case, the number of bits per key may be less.

SHA algorithms and variants typically use a pre-defined output size ranging from 160 bits for SHA-1 to 512 bits for SHA3-512.

As an alternative to cryptographic hash functions such as SHA-2 and SHA-3, cyclic redundancy check (CRC) may be used as an alternative hash function to generate the key value. Although CRC is shorter and weaker than SHA, it may be sufficient for generating the key value, because the security concern of the pairing key is less stringent. Specifically, an input string A may be constructed using the characteristic information of the trained two-sided model as shown above. Then the input string A is passed to a length-n CRC encoder. The length-n output string B (i.e., CRC bits of string A) is then used as the key. For a length-n CRC encoder, a degree-n CRC polynomial is used. To avoid collision, a longer length CRC may be used, for example, 24-bit, 32-bit, 40-bit, or 64-bit CRC. Example CRC polynomials are shown below:
24-bit CRC: g_{24B}(D)=D²⁴+D²³+D⁶+D⁵+D+1, used in LTE and NR;
40-bit CRC: g₄₀(D)=D⁴⁰+D²⁶+D²³+D¹⁷+D³+1, used in global system for mobile communication (GSM);

$$64 - bit CRC : {g}_{64} ( D ) = {D}^{64} + {D}^{4} + {D}^{3} + D + 1$$

Some embodiments include usage of the random keys. For a given functionality, the key may be used as a type of ID for the AI/ML model together with its operating context or conditions. In particular embodiments, AI/ML models trained to operate under different contexts or operating conditions are given different keys.

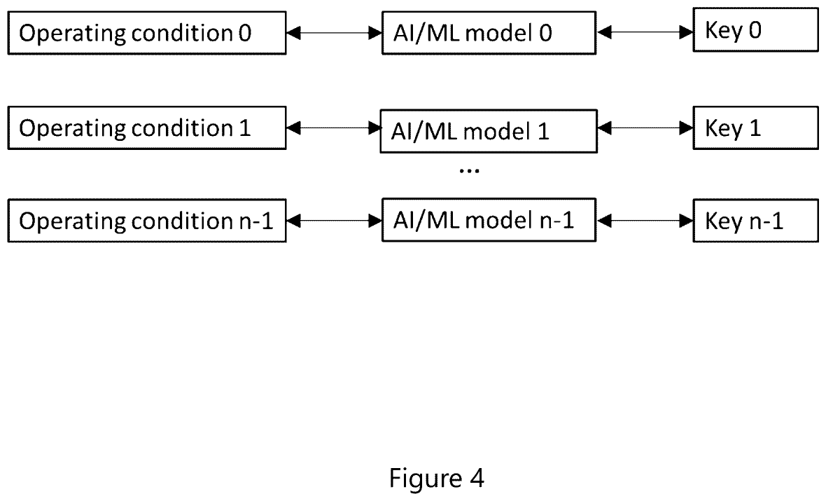

In one example, for a given functionality, one key is defined for one combination of AI/ML model and its operating condition. This is illustrated in FIG. 4.

FIG. 4 illustrates defining one key for one combination of AI/ML model and its operating condition.

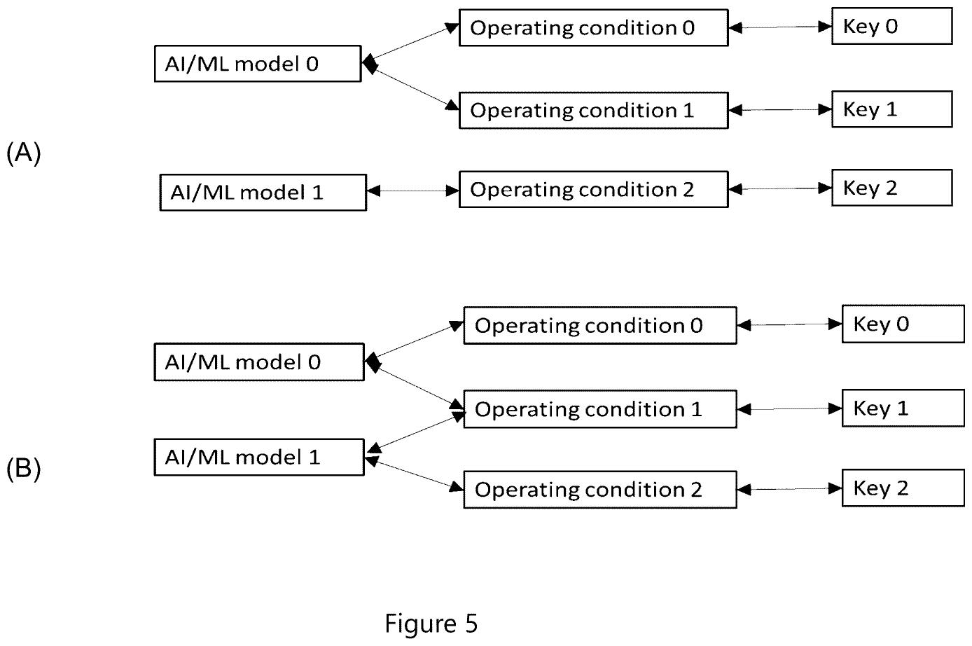

In another example, for a given functionality, one key is defined for one operating condition of the AI/ML model, where a model may be trained to operate under multiple conditions. This is illustrated in FIGS. 5 (a) and (b). For example, in FIG. 5 (a), AI/ML model 0 is an advanced model, where it is trained with a mixed dataset which contains data from operating condition 0 and 1, thus allowing AI/ML model 0 to function under both operating condition 0 and 1. In FIG. 5 (b), AI/ML model 0 is trained to operate under condition 0 and 1, AI/ML model 1 is trained to operate under condition 1 and 2. Thus under operating condition 1, the UE may switch from model 0 and 1 to be prepared for the next anticipated operating condition (e.g., operating condition 2).

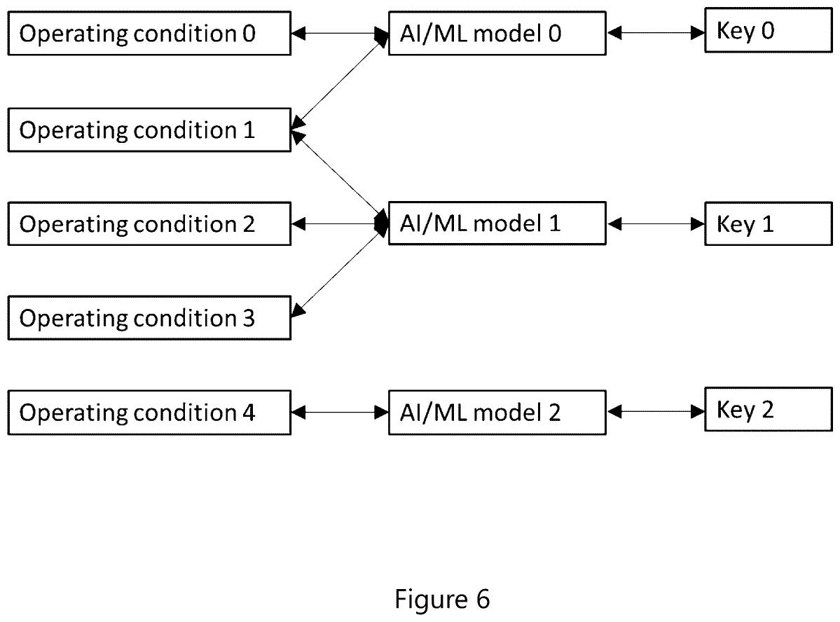

In another example, for a given functionality, one key is defined for one AI/ML model, where each model has its associated operating conditions. This is illustrated in FIG. 6. The associated operating conditions may be carried as a part of the metadata of the AI/ML model.

Examples of operating conditions include: (a) a set of frequencies where an AI/ML model is operational; (b) a set of serving cells where an AI/ML model is operational; (c) a set of multiple-input multiple-output (MIMO) configurations where an AI/ML model is operational; and/or (d) a set of supported reference signal configurations, such as the UE time/spatial-domain prediction capabilities of channel state information reference signal (CSI-RS) measurements in a certain time-frequency resource.

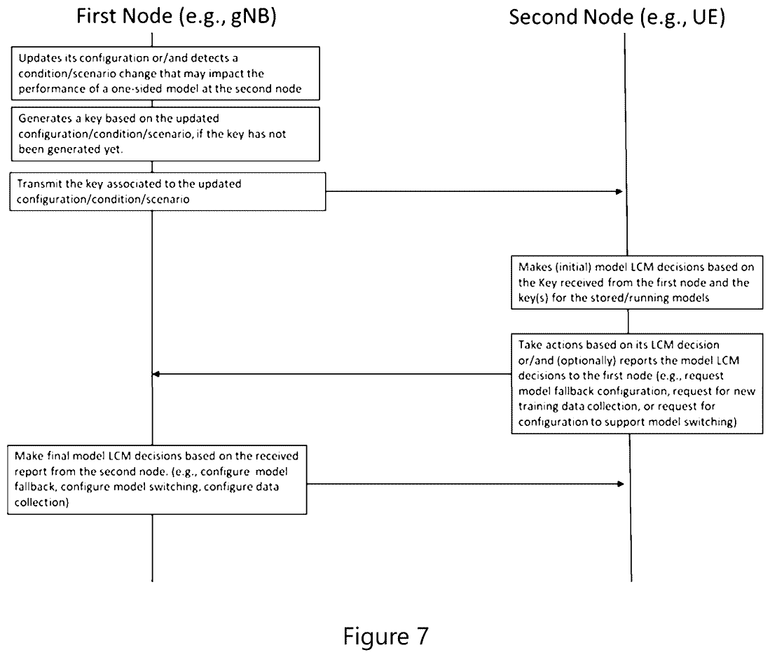

Some embodiments include signaling procedure for “key”-based one-sided model LCM. FIG. 7 illustrates an example of the usage of stored keys for trained one-sided models at the second node together with the signaling of a key from the first node to the second node during operation.

Procedure 1 is for indicating condition/configuration/scenario changes and support model LCM accordingly. The first node (e.g., a network node) updates its configuration or detects scenario/condition change that is associated to an AI-model-based feature. The first node transmits/broadcasts/multicasts a key generated based on the updated configuration/scenario/condition to the second node (e.g., a UE).

The second node receives the key and compares it with the key for the running model (optionally, also compare it with the key(s) for all the stored models) for this AI feature. The second node makes (initial) model LCM decisions. If no stored key matches to the received node, then, the second node automatically falls back to non-ML feature/algorithm or requests fallback, or/and trigger model monitoring procedure, or/and trigger data collection procedure. If the key for the running model matches to the received key, then continue using the current model. If one stored key of the non-running model matches the received key, then, activate/switch-to this matched model.

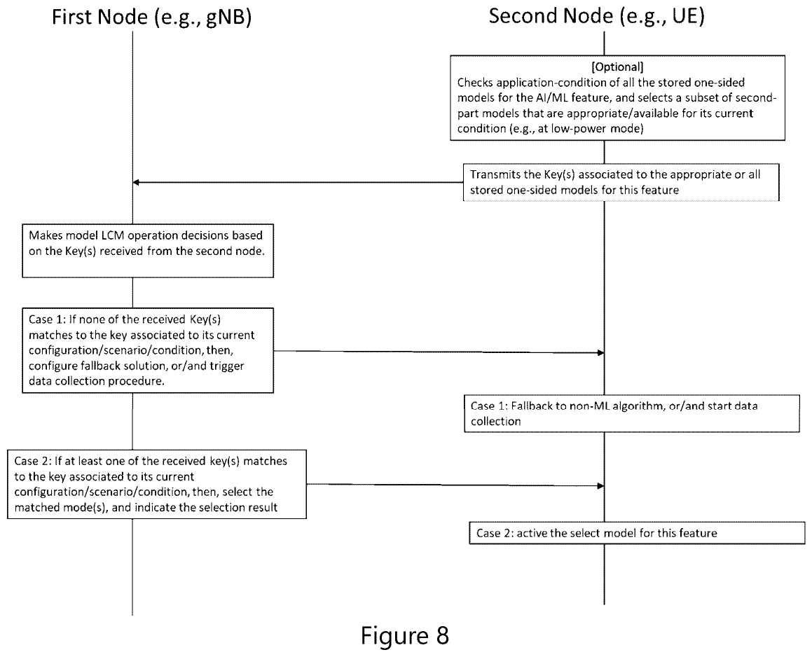

FIG. 8 illustrates an example of key-based UE capability reporting for one-sided model LCM. Procedure 2 is for reporting the capability of the second node to the first node, and support model LCM accordingly. The second node (e.g., a UE) reports the key(s) for all its stored or currently applicable/available one-sided model(s) for an AI-model-based feature to the first node (e.g., a network node).

The first node indicates model LCM operations to the second node based on the received keys. If at least one of the received key(s) matches the current condition/configuration/scenario, then, the first node selects the matched model(s) for the second node, and indicates the selection result to the second node. The indication of the selected result may be via the first node sending the selected key(s) to the second node. If none of the received key(s) matches to the current condition/configuration/scenario, then, configure the second node to fallback to non-ML feature/algorithm, or/and trigger data collection procedure for the second node.

Additionally, the first node may keep track of the reported keys from a list of second nodes. If the current configuration is Config #A, and most (or all) of the second nodes report the support of a different configuration (e.g., Config #B) via the keys, then the first node may perform reconfiguration to change from Config #A to Config #B.

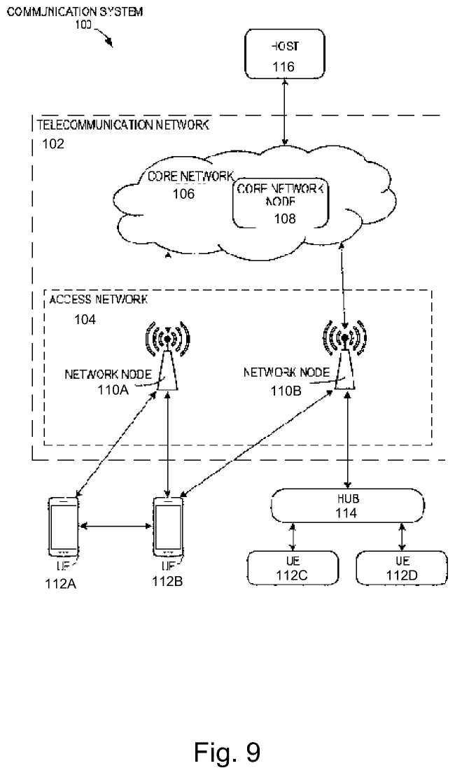

FIG. 9 shows an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3^{rd} Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

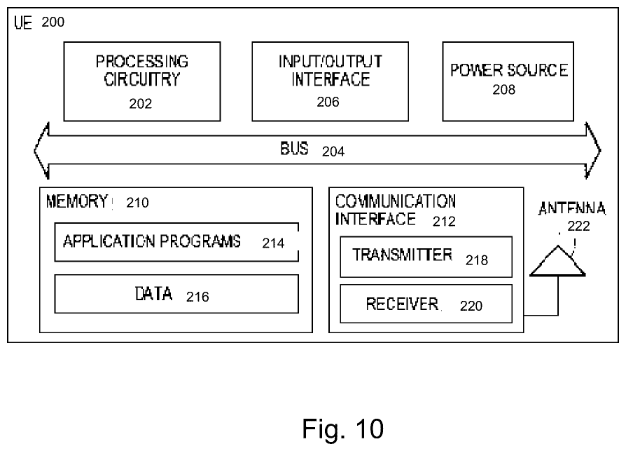

FIG. 10 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

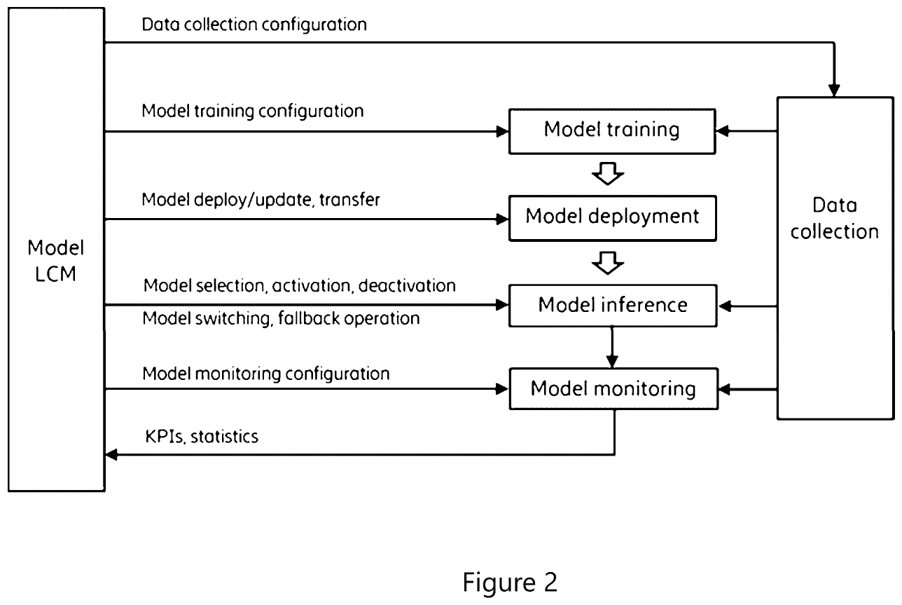

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 2. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 2.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

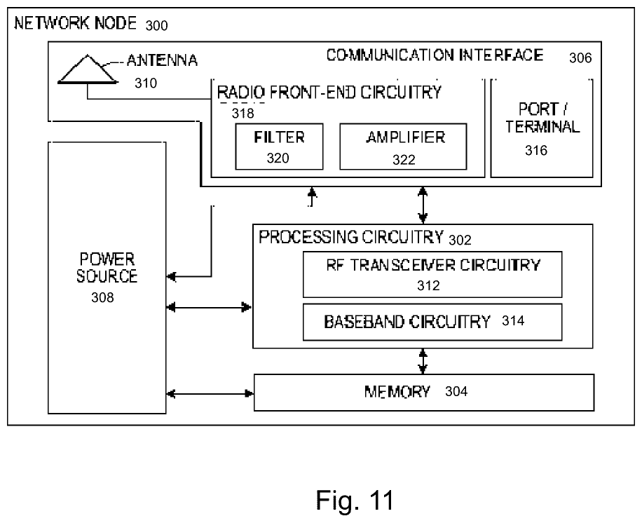

FIG. 11 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 11 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

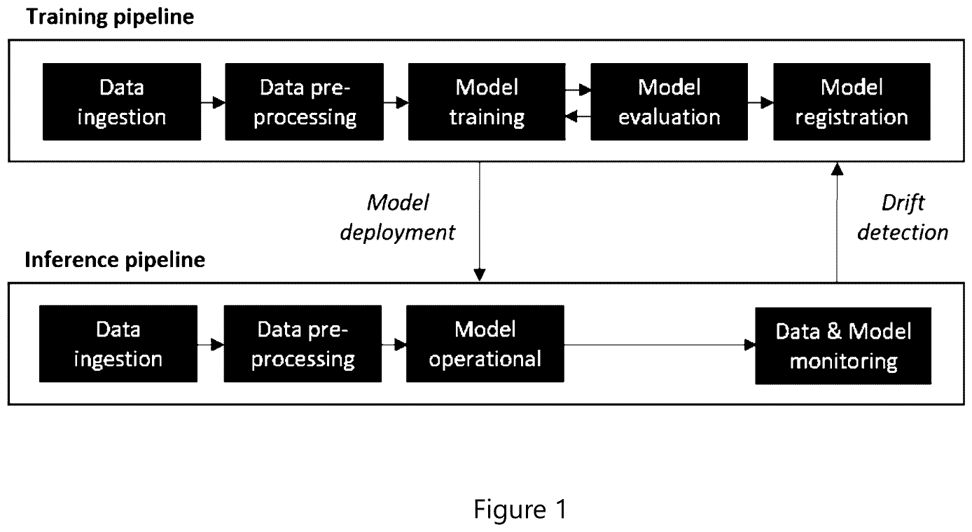

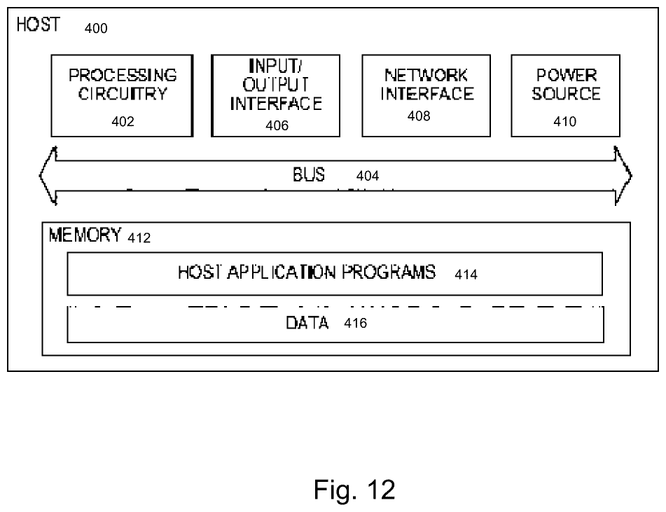

FIG. 12 is a block diagram of a host 400, which may be an embodiment of the host 116 of FIG. 1, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

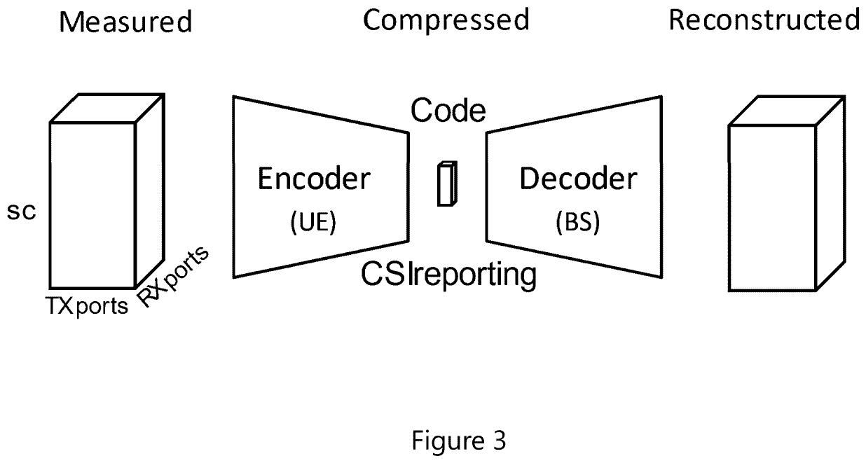

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 10 and 3, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

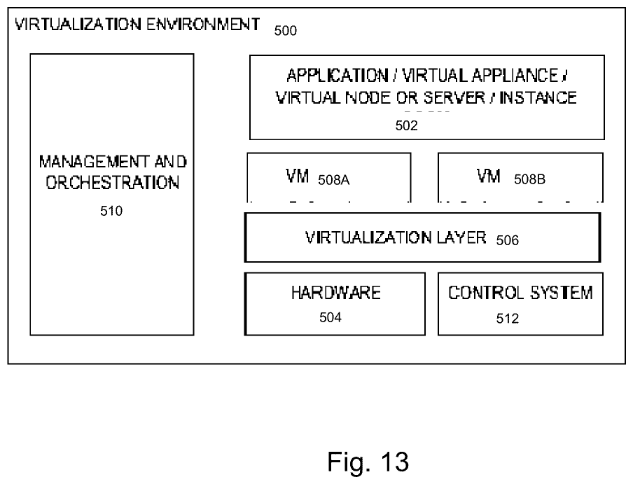

FIG. 13 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

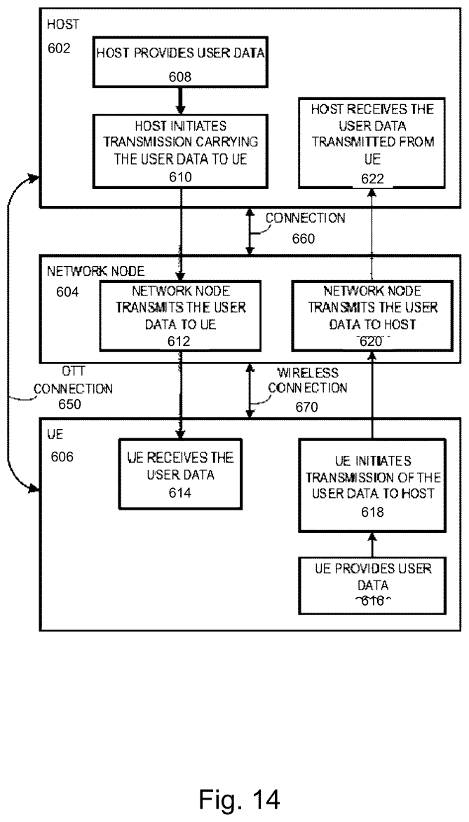

FIG. 14 shows a communication diagram of a host 602 communicating via a network node 604 with a UE 606 over a partially wireless connection in accordance with some embodiments. Example implementations, in accordance with various embodiments, of the UE (such as a UE 112a of FIG. 9 and/or UE 200 of FIG. 2), network node (such as network node 110a of FIG. 9 and/or network node 300 of FIG. 3), and host (such as host 116 of FIG. 9 and/or host 400 of FIG. 4) discussed in the preceding paragraphs will now be described with reference to FIG. 6.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 1) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve the data rate and latency and thereby provide benefits such as reduced user waiting time, better responsiveness, and better QoE.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

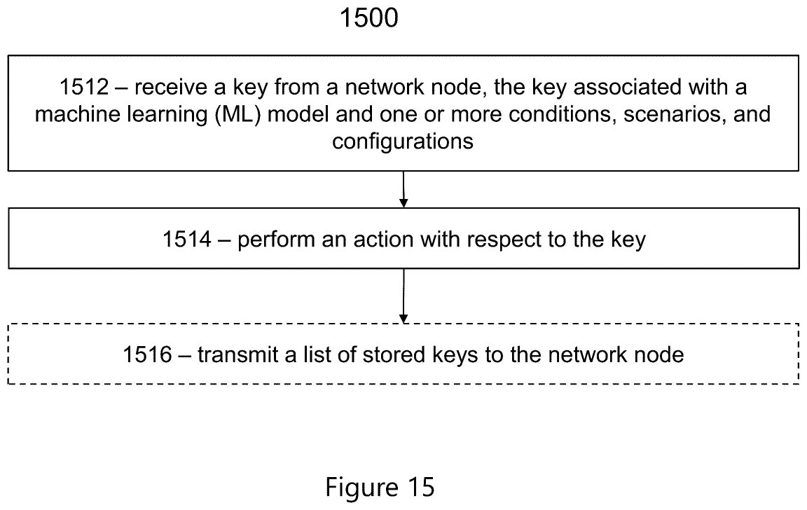

FIG. 15 is a flowchart illustrating an example method in a wireless device, according to certain embodiments. In particular embodiments, one or more steps of FIG. 15 may be performed by UE 200 described with respect to FIG. 10.

The method begins at step 1512, where the wireless device (e.g., UE 200) receives a key from a network node. The key is associated with a ML model and one or more conditions, scenarios, and configurations. The key may comprise a hash key, a CRC, or any of the keys described in the embodiments and examples above. The key may be derived from any one or more of the conditions, scenarios, and configurations described in the embodiments and examples above.

At step 1514, wireless device performs an action with respect to the key. For example, in particular embodiments if the key does not match a stored key, then the wireless device performs one or more of the following: fallback to a non-ML feature/algorithm; request fallback to a non-ML feature/algorithm; trigger an ML-model monitoring procedure; and/or trigger a data collection procedure. If the key matches a key associated with a currently running ML model, then the wireless device may continue using the currently running ML model. If the key matches a stored key, the wireless device may activate or switch to an ML model associated with the key. In particular embodiments, the wireless device may perform any of the actions described in the embodiments and examples above.

At step 1516, the wireless device may transmit a list of stored keys to the network node. For example, the list of keys may represent a capability of the wireless device for supporting particular ML models and particular conditions, scenarios, and/or configurations. The network node may use the list to select an appropriate ML model for the wireless device.

Modifications, additions, or omissions may be made to method 1500 of FIG. 15. Additionally, one or more steps in the method of FIG. 15 may be performed in parallel or in any suitable order.

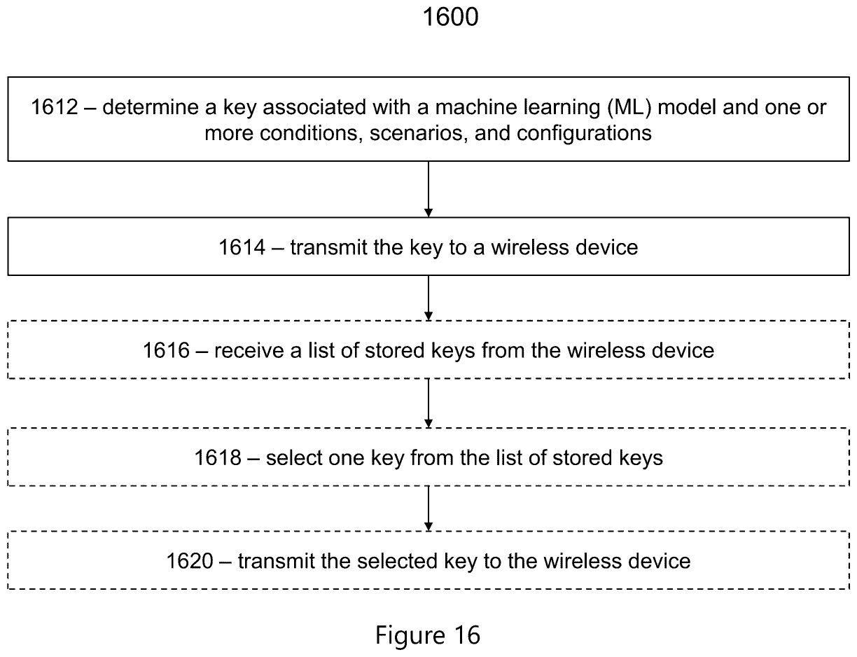

FIG. 16 is a flowchart illustrating an example method in a network node, according to certain embodiments. In particular embodiments, one or more steps of FIG. 16 may be performed by network node 300 described with respect to FIG. 11.

The method begins at step 1612, where the network node (e.g., network node 300) determines a key associated with a ML model and one or more conditions, scenarios, and configurations. The network node may determine the key according to any of the embodiments and examples described above.

At step 1614, the network node transmits the key to a wireless device. The wireless device associates the key with an ML model and the and one or more conditions, scenarios, and configurations.

At step 1616, the network node may receive a list of stored keys from the wireless device. The list of keys may represent a capability of the wireless device for supporting particular ML models and particular conditions, scenarios, and/or configurations.

At step 1618, the network node may select one key from the list of stored keys. Selecting one key may be based on one or more of a current conditions, scenarios, and configurations. For example, network conditions may have changed an the wireless device may not be operating with the optimal ML model. The network node may select a better model based on the list of keys and the current conditions.

The method then continues to step 1620, where the network node transmits the selected key to the wireless device. The wireless device may then switch to or activate the ML model indicated by the key.

Modifications, additions, or omissions may be made to method 1600 of FIG. 16. Additionally, one or more steps in the method of FIG. 16 may be performed in parallel or in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

Some example embodiments are described below.

### Group A Embodiments

1. A method performed by a wireless device, the method comprising:
   receiving a key from a network node, the key associated with an AI/ML model and one or more conditions/scenarios/configurations; and
   performing an action with respect to the key.
2. The method of embodiment 1, wherein the action comprises, if the key does not match a stored key, then, fallback to non-ML feature/algorithm or requests fallback, or/and trigger model monitoring procedure, or/and trigger data collection procedure.
3. The method of any one of the previous embodiments, wherein the action comprises, if the key matches a key associated with a currently running AI/ML model, then continue using the currently running AI/ML model.
4. The method of any one of the previous embodiments, wherein the action comprises, if the key matches a stored key, activate/switch to an AI/ML model associated with the key.
5. T The method of any one of the previous embodiments, further comprising transmitting a list of stored keys to the network node.
6. A method performed by a wireless device, the method comprising:
   any of the wireless device steps, features, or functions described above, either alone or in combination with other steps, features, or functions described above.
7. The method of the previous embodiment, further comprising one or more additional wireless device steps, features or functions described above.
8. The method of any of the previous embodiments, further comprising:
   providing user data; and
   forwarding the user data to a host computer via the transmission to the base station.

### Group B Embodiments

9. A method performed by a base station, the method comprising:
   a. determining a key associated with an AI/ML model and one or more conditions/scenarios/configurations; and
   b. transmitting the key to a wireless device.
10. The method of embodiment 9, further comprising receiving a list of stored keys from the wireless device.
11. A method performed by a base station, the method comprising:
   any of the steps, features, or functions described above with respect to base station, either alone or in combination with other steps, features, or functions described above.
12. The method of the previous embodiment, further comprising one or more additional base station steps, features or functions described above.
13. The method of any of the previous embodiments, further comprising:
   obtaining user data; and
   forwarding the user data to a host computer or a wireless device.

### Group C Embodiments

14. A mobile terminal comprising:
   processing circuitry configured to perform any of the steps of any of the Group A embodiments; and
   power supply circuitry configured to supply power to the wireless device.
15. A base station comprising:
   processing circuitry configured to perform any of the steps of any of the Group B embodiments;
   power supply circuitry configured to supply power to the wireless device.
16. A user equipment (UE) comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
17. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
18. The communication system of the pervious embodiment further including the base station.
19. The communication system of the previous 2 embodiments, further including the UE, wherein the UE is configured to communicate with the base station.
20. The communication system of the previous 3 embodiments, wherein:
   the processing circuitry of the host computer is configured to execute a host application, thereby providing the user data; and
   the UE comprises processing circuitry configured to execute a client application associated with the host application.
21. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
22. The method of the previous embodiment, further comprising, at the base station, transmitting the user data.
23. The method of the previous 2 embodiments, wherein the user data is provided at the host computer by executing a host application, the method further comprising, at the UE, executing a client application associated with the host application.
24. A user equipment (UE) configured to communicate with a base station, the UE comprising a radio interface and processing circuitry configured to performs any of the previous 3 embodiments.
25. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
26. The communication system of the previous embodiment, wherein the cellular network further includes a base station configured to communicate with the UE.
27. The communication system of the previous 2 embodiments, wherein:
   the processing circuitry of the host computer is configured to execute a host application, thereby providing the user data; and
   the UE's processing circuitry is configured to execute a client application associated with the host application.
28. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
29. The method of the previous embodiment, further comprising at the UE, receiving the user data from the base station.
30. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
31. The communication system of the previous embodiment, further including the UE.
32. The communication system of the previous 2 embodiments, further including the base station, wherein the base station comprises a radio interface configured to communicate with the UE and a communication interface configured to forward to the host computer the user data carried by a transmission from the UE to the base station.
33. The communication system of the previous 3 embodiments, wherein:
   the processing circuitry of the host computer is configured to execute a host application; and
   the UE's processing circuitry is configured to execute a client application associated with the host application, thereby providing the user data.
34. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
35. A method implemented in a communication system including a host computer, a base station and a user equipment (UE), the method comprising:
   at the host computer, receiving user data transmitted to the base station from the UE, wherein the UE performs any of the steps of any of the Group A embodiments.
36. The method of the previous embodiment, further comprising, at the UE, providing the user data to the base station.
37. The method of the previous 2 embodiments, further comprising:
   at the UE, executing a client application, thereby providing the user data to be transmitted; and
   at the host computer, executing a host application associated with the client application.
38. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
39. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
40. The communication system of the previous embodiment further including the base station.
41. The communication system of the previous 2 embodiments, further including the UE, wherein the UE is configured to communicate with the base station.
42. The communication system of the previous 3 embodiments, wherein:
   the processing circuitry of the host computer is configured to execute a host application;
   the UE is configured to execute a client application associated with the host application, thereby providing the user data to be received by the host computer.
43. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
44. The method of the previous embodiment, further comprising at the base station, receiving the user data from the UE.
45. The method of the previous 2 embodiments, further comprising at the base station, initiating a transmission of the received user data to the host computer.

1. A method performed by wireless device for time-based activation of a measurement gap configuration, the method comprising:
receiving a key from a network node, the key associated with a machine learning (ML) model and one or more conditions, scenarios, and configurations; and
performing an action with respect to the key.

2. The method of claim 1, wherein the action comprises, if the key does not match a stored key, then performing one or more of the following:
fallback to a non-ML feature/algorithm;
request fallback to a non-ML feature/algorithm;
trigger an ML-model monitoring procedure;
trigger a data collection procedure.

3. The method of claim 1, wherein the action comprises, if the key matches a key associated with a currently running ML model, then continue using the currently running ML model.

4. The method of claim 1 wherein the action comprises, if the key matches a stored key, activate or switch to an ML model associated with the key.

5. The method of claim 1, further comprising transmitting a list of stored keys to the network node.

6. A wireless device comprising processing circuitry operable to:
receive a key from a network node, the key associated with a machine learning (ML) model and one or more conditions, scenarios, and configurations; and
perform an action with respect to the key.

7. The wireless device of claim 6, wherein the action comprises, if the key does not match a stored key, then performing one or more of the following:
fallback to a non-ML feature/algorithm;
request fallback to a non-ML feature/algorithm;
trigger an ML-model monitoring procedure;
trigger a data collection procedure.

8. The wireless device of claim 6, wherein the action comprises, if the key matches a key associated with a currently running ML model, then continue using the currently running ML model.

9. The wireless device of claim 6, wherein the action comprises, if the key matches a stored key, activate or switch to an ML model associated with the key.

10. The wireless device of claim 6, the processing circuitry further operable to transmit a list of stored keys to the network node.

11. A method performed by a network node, the method comprising:
determining a key associated with a machine learning (ML) model and one or more conditions, scenarios, and configurations; and
transmitting the key to a wireless device.

12. The method of claim 11, further comprising receiving a list of stored keys from the wireless device.

13. The method of claim 12, further comprising:
selecting one key from the list of stored keys; and
transmitting the selected key to the wireless device.

14. The method of claim 13, wherein selecting one key is based on one or more of a current conditions, scenarios, and configurations.

15. A network node comprising processing circuitry, the processing circuitry operable to:
determine a key associated with a machine learning (ML) model and one or more conditions, scenarios, and configurations; and
transmit the key to a wireless device.

16. The network node of claim 15, the processing circuitry further operable to receive a list of stored keys from the wireless device.

17. The network node of claim 16, the processing circuitry further operable to:
select one key from the list of stored keys; and
transmit the selected key to the wireless device.

18. The network node of claim 17, wherein selecting one key is based on one or more of a current conditions, scenarios, and configurations.
